(19) United States
(12) Patent Application Publication
(10) Pub. No.: US 2009/0094897 A1
(43) Pub. Date: Apr. 16, 2009

(54) LIFTGATE HYDRAULIC CLOSURE CYLINDER

(76) Inventors: Dane W. Gregg, Uniontown, OH (US); Peter J. Savoy, Akron, OH (US)

Correspondence Address: Emerson, Thomson & Bennett, LLC, 777 W. Market Street, Akron, OH, 44303, US

(21) Appl. No.: 11/935,642

(22) Filed: Nov. 6, 2007

Related U.S. Application Data
(60) Provisional application No. 60/941,825, filed on Jun. 4, 2007.

(51) Int. Cl. E05F 15/02; B60P 1/02

(52) U.S. Cl. 49/137; 414/557; 414/809

(57) ABSTRACT

A liftgate system may include a closer cylinder assembly for use in opening and closing a deck. The closer cylinder assembly may have a hydraulic fluid portion on one side of a piston and an air (or other gas) portion on the other side of the piston. The deck is closed using hydraulic pressure in the hydraulic fluid portion to move the piston in one direction. The deck is assisted in opening using gas pressure in the gas portion to move the piston in another direction.

This application claims priority to U.S. Ser. No. 60/846,418, entitled HYDRAULIC CLOSURE CYLINDER WITH PNEUMATIC PLATFORM OPENING CYLINDER FOR LIFTGATE SYSTEM, filed Nov. 6, 2006, which is incorporated herein by reference and U.S. Ser. No. 60/941,825, entitled LIFTGATE HYDRAULIC CLOSURE CYLINDER II, filed Jun. 4, 2007, which is incorporated herein by reference.

### I. BACKGROUND OF THE INVENTION

A. Field of Invention

This invention pertains to the art of methods and apparatuses regarding liftgates and more specifically to methods and apparatuses regarding opening and closing liftgates.

B. Description of the Related Art

It is well known in the art to attach liftgates to vehicle trailers or other forms of vehicle cargo holds to assist with loading and unloading of the vehicles. In general, liftgates include a platform or deck and an adjustment system used to move the platform. To load cargo from a ground surface to the vehicle bed, the deck is positioned in a lowered position where it is generally parallel with the ground surface. The cargo can then be easily placed onto the cargo receiving surface of the deck. The deck is then lifted to a raised position generally parallel with the vehicle bed. The cargo can then be moved from the cargo receiving surface and loaded into the vehicle. To unload cargo from the vehicle, the reverse steps are taken.

Various types and styles of liftgates are known in the art. Some non-limiting examples include conventional liftgates, flip-a-way or fold-up liftgates, rail type liftgates, and special purpose liftgates. FIG. 1 shows a known rail type liftgate system and provides a list of the major components. FIG. 2 illustrates the basic operation of the liftgate system. Note that the rail type liftgate platform or deck 19 is not only raised and lowered with a lift cylinder 6 but is also opened and closed with a closer cylinder 17. A more detailed view of the closer cylinder 17 is shown in FIG. 3 and a hydraulic schematic of the liftgate system is shown in FIG. 4. One or more torsion springs 38, one visible in FIG. 1, are used in a known manner to assist in opening the deck 19. While the liftgate system shown in FIGS. 1-4 works well for its intended purpose, such liftgate systems have disadvantages.

One disadvantage is related to the fact that the required force to open the deck often varies. The required deck opening force varies for several reasons. The most common of these reasons are: (a) damage to the deck/platform; (b) corrosion to the deck hinge; (c) atmospheric temperatures; and, (d) the positioning of the vehicle, and thus the liftgate system, on an incline, such as when the vehicle is parked on the side of a hill. As noted above, known liftgate systems use a torsion spring to assist with opening the deck. The use of such a spring, however, does not permit adjustment for varied opening forces (except that the spring could be replaced with another spring having different characteristics—this is expensive, time consuming and impractical).

Another disadvantage is noise. Specifically, conventional wire springs typically have a higher initial opening torque magnitude and the torque reduces to zero at an angle prior to the deck opening rotation range. This allows the inertial gravity forces to continue opening the deck after the applied wire spring torque is zero. The resistance of hydraulic fluid is typically designed to be relatively low so as not to hinder the opening of the deck. This typically causes a relatively fast opening of the deck which may cause a relatively loud noise. Such a loud noise may be a detriment to the operation of the liftgate assembly—especially in areas with strict noise abatement miles and regulations such as hospitals and residential areas.

The present invention provides methods and apparatuses to easily vary a liftgate system opening force and thus overcomes the foregoing difficulties and others while providing better and more advantageous overall results.

### II. SUMMARY OF THE INVENTION

According to one embodiment of this invention, a liftgate system may include a cylinder assembly used to open the deck of a liftgate. The cylinder assembly may have a hydraulic fluid portion on one side of a piston and an air (or other gas) portion on the other side of the piston. The deck is closed using hydraulic pressure in the hydraulic fluid portion to move the piston in one direction. The deck is assisted in opening using gas pressure in the gas portion to move the piston in another direction.

According to another embodiment of this invention, energy, in the form of compressed gas, to be used in opening the deck can be stored within the cylinder or in an auxiliary device connected to the gas portion of the cylinder.

According to another embodiment of this invention, a gas system may include a regulator for use in pre-setting the pressure of the gas within the gas system.

According to still another embodiment of this invention, a hydraulic system may include a flow control valve for use in controlling the flow rate of the hydraulic fluid.

One advantage of this invention is that the force required to open a liftgate deck can be easily adjusted to meet the required operating conditions.

Another advantage of this invention is that the liftgate deck can be opened in a relatively slow and controlled manner.

Another advantage of this invention is that a liftgate deck can opened in a quieter manner.

Another advantage of this invention is that the liftgate deck opening force can be adjusted to compensate for wear on the deck.

Still another advantage of this invention is that liftgate assembly costs can be minimized.

Yet another advantage of this invention, according to one embodiment, is that the flow rate of leaking hydraulic fluid, should the hydraulic line become cut, can be controlled.

Still other benefits and advantages of the invention will become apparent to those skilled in the art to which it pertains upon a reading and understanding of the following detailed specification.

### III. BRIEF DESCRIPTION OF THE DRAWINGS

The invention may take physical form in certain parts and arrangement of parts, embodiments of which will be described in detail in this specification and illustrated in the accompanying drawings which form a part hereof and wherein:

FIG. 1 is a plan perspective view of a prior art rail type liftgate.

FIG. 2 illustrates the operation of the liftgate system shown in FIG. 1.

FIG. 3 is a close-up side view of the closer cylinder shown in FIG. 1.

FIG. 4 is a hydraulic schematic of a hydraulic system that may be used with the liftgate system shown in FIG. 1.

FIG. 5 is a perspective view of a cylinder assembly according to one embodiment of this invention.

FIG. 6 is a side view, shown partially cut-away, of the cylinder assembly shown in FIG. 5.

FIG. 7 is a side view, at a different angle than shown in FIG. 6, of the cylinder assembly shown in FIG. 5 but also including a hydraulic line.

FIG. 8 is an end view of the cylinder assembly shown in FIG. 5.

FIG. 9 is a hydraulic schematic of a hydraulic system that may be used with one embodiment of this invention.

FIG. 10 is a view of the cylinder assembly shown in FIG. 7 but with a flow control valve added.

### IV. DETAILED DESCRIPTION OF THE INVENTION

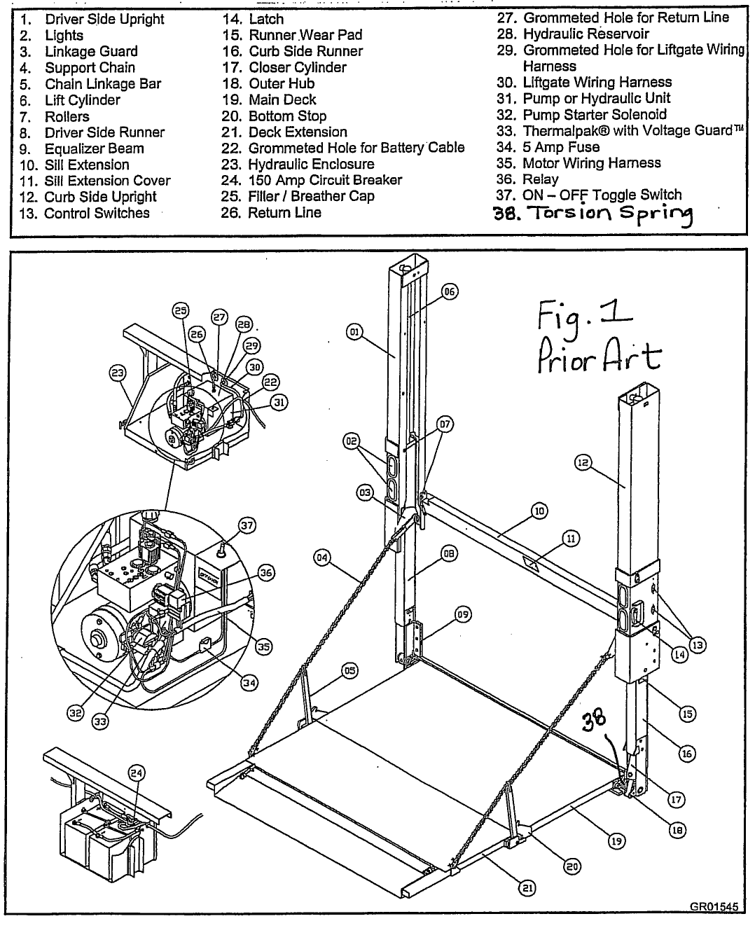

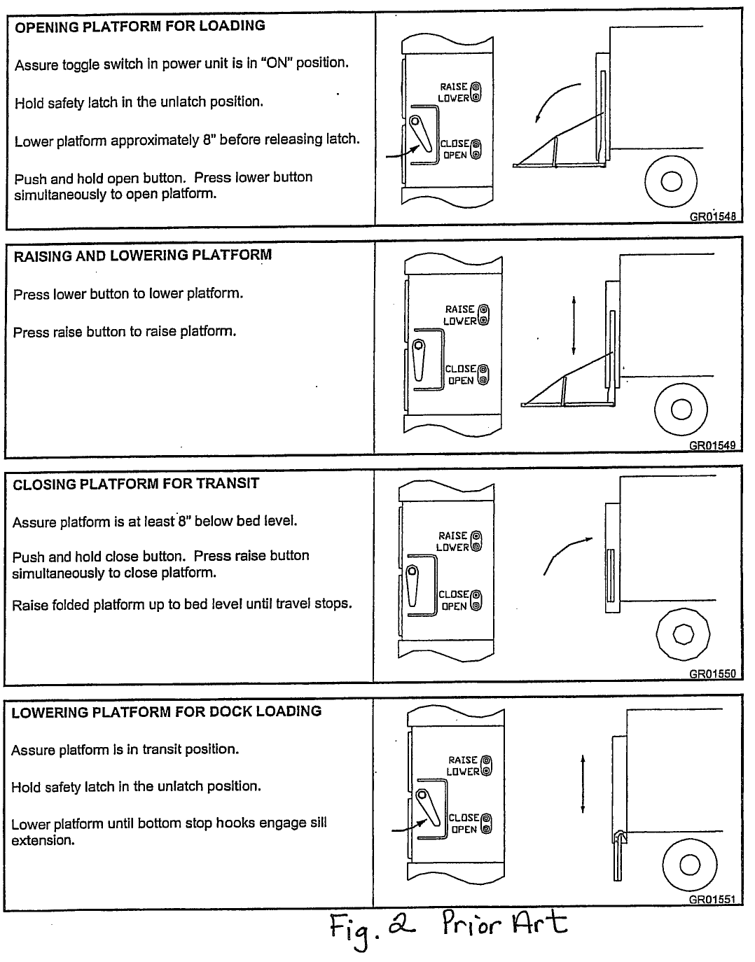

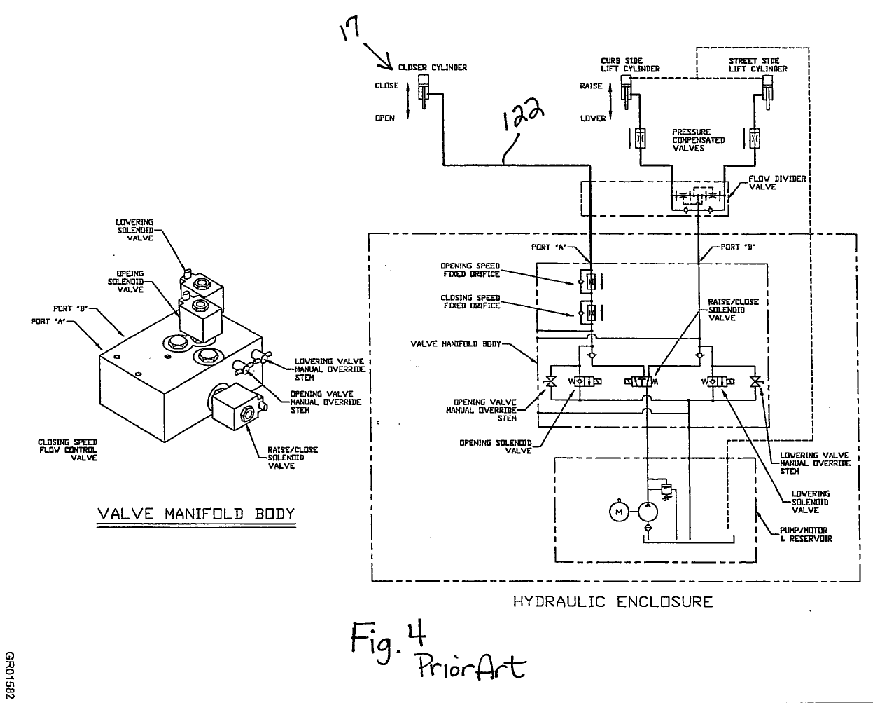

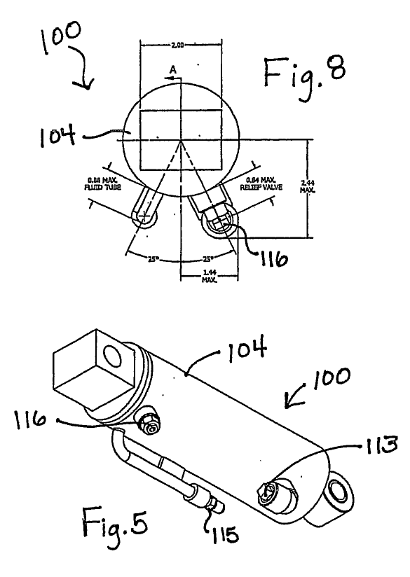

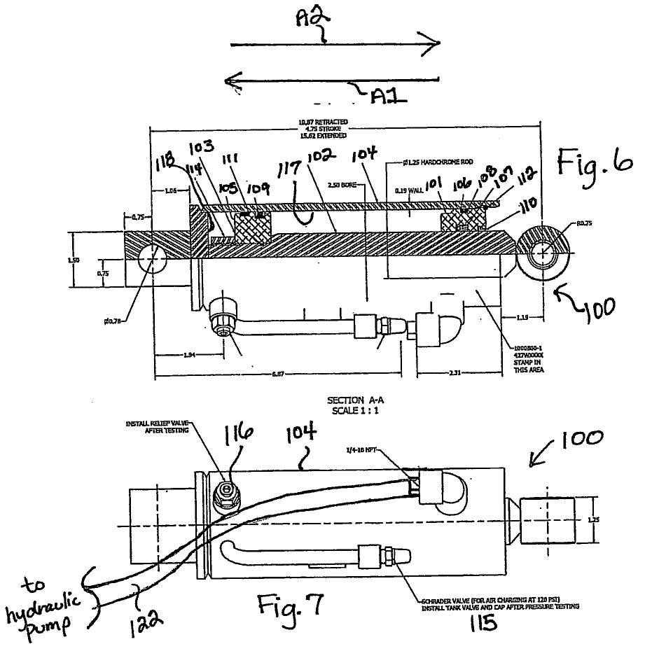

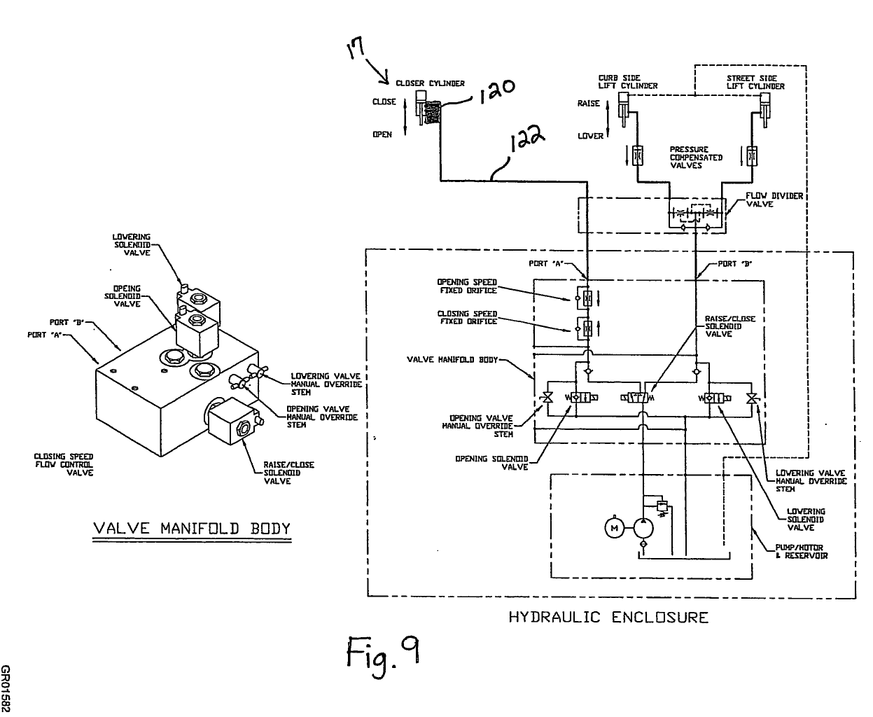

Referring now to the drawings wherein the showings are for purposes of illustrating embodiments of the invention only and not for purposes of limiting the same, FIGS. 5-8 show a cylinder assembly 100 that can be used in place of the closer cylinder 17 and torsion spring 38 described above with regard to the liftgate system shown in FIGS. 1-4. The overall operation of a liftgate system using the inventive cylinder assembly 100 is as described above except as described below.

With continuing reference to FIGS. 5-8, the primary components of the cylinder assembly 100 are as follows:
100 cylinder assembly
101 gland
102 rod assembly
103 piston
104 barrel assembly
105 o-ring
106 o-ring
107 rod seal
108 backup ring
109 piston seal
110 rod wiper
111 wear-ring
112 retaining ring
113 cap-plug
114 locknut
115 tank valve, ⅛ npt, w/cap
116 gas relief valve, set, in one embodiment, at 500-569 psi

Still referring to FIGS. 5-8, the cylinder assembly 100 includes a piston 103 connected to a rod assembly 102. The piston 103 is positioned within a barrel assembly 104, as shown. The cylinder assembly 100 has a hydraulic fluid portion 117 on one side of the piston 103 and an air (or other gas) portion 118 on the other side of the piston 103. The deck is closed using hydraulic pressure in the hydraulic fluid portion 117 to move the piston 103 in direction A1. The deck is assisted in opening using gas pressure in the gas portion 118 to move the piston 103 in direction A2. As a result, a spring is not required. Energy, in the form of compressed gas, to be used in opening the deck can be stored within the cylinder 100 or in an auxiliary device connected to the gas portion 118 of the cylinder 100. The auxiliary storage may include a pneumatic or pneumatic over hydraulic accumulator. As the deck is closed with hydraulic pressure, the gas pressure within the gas portion 118 and/or auxiliary device increases. When the hydraulic pressure is released from the hydraulic fluid portion 117 of the cylinder 100, the gas pressure within the gas portion 118 is sufficient to urge the piston in direction A2 and thereby open the deck.

With continuing reference to FIGS. 5-8, the gas pressure is retained in the gas portion 118 of the cylinder 100 by the piston 102, piston seal 109, cylinder walls, cylinder end closure and by a plurality of air/gas valve types. The valve is placed within a valve stem or directly into the cylinder. The valve stem may be, but is not limited to, a “tire valve” type stem or a metal line. A pressure relief valve 116 may be connected to the gas portion 118 of the cylinder 100 to prevent over-pressurization. In one embodiment, the gas portion 118 is pressurized to a desired pressure, the “set-pressure,” when the deck is in the open position—in which case the piston 103 will move fully in the A2 direction. An operator can vary the set-pressure to adapt to a variety of deck opening resistance operating conditions; some of which were noted above.

With reference now to FIGS. 1-8, using the cylinder assembly 100 of this invention permits greater control of the deck 19 opening compared to other energy storage methods. This improvement is believed to be due to the operation of at least three mechanisms. The first is that the pneumatic torque is applied at a lower magnitude. The second mechanism is that lower torque is applied over the entire deck opening rotation range. The third mechanism is that the hydraulic fluid flow resistance is set higher than in the convention case. This reduces the inertial gravity forces opening the deck. The combination of these three mechanisms is believed to permit the deck to open in a slower, more controlled, and quieter manner.

With continuing reference to FIGS. 1-8, this invention permits easy adjustment of the deck opening force by simply adjusting the gas pressure in the gas portion 118 of the cylinder 100. The gas pressure may be set, for example, at any pressure between 0 and 120 pounds per square inch (PSIG). This range of pressure is readily available from a variety of commercial sources and engine compressors. The invention is not limited to the listed operating conditions. The particular device used to adjust the gas pressure can be any chosen with sound engineering judgment such as, for example, a gas pressure regulator.

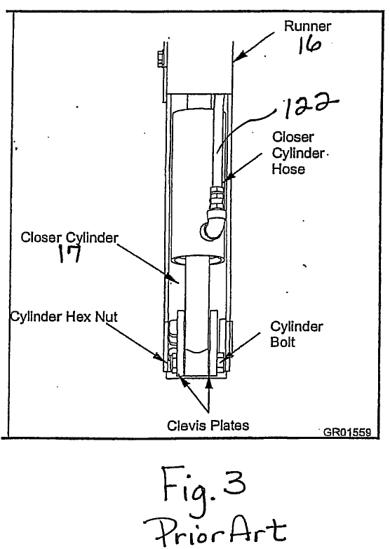

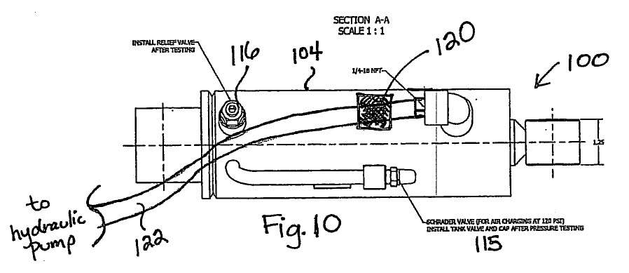

With reference now to FIGS. 9-10, in another embodiment, a flow control valve 120 is added to the hydraulic fluid portion 117 of the cylinder assembly 100, as shown. The flow control valve 120 provides several advantages. One advantage is revealed in the situation where the hydraulic line 122, which provides hydraulic fluid to the cylinder assembly 100, becomes “cut” or opened. To understand this advantage, with reference to FIGS. 3, 4 and 6, first consider a case where the hydraulic line 122 is cut (or otherwise opened) without the use of a flow control valve. In this case, the hydraulic pressure supplied to the hydraulic fluid portion 117 of the cylinder assembly 100 would drop and the gas pressure in the gas portion 118 would cause the piston 103 to move in direction A2. Note that the speed of motion in direction A2 as well as the flow rate of leaking hydraulic fluid would only be limited by the pressure in the gas portion 118 and the size of the opening in the hydraulic line 122. If the opening in the hydraulic line 122 is relatively large, there is the chance for a relatively fast flow rate of leaking hydraulic fluid which could, for instance, “spray” a person who may be near the liftgate.

Now, with reference again to FIGS. 9-10, consider the case where the hydraulic line 122 is cut (or otherwise opened) with the use of a flow control valve 120. In this case, the hydraulic pressure supplied to the hydraulic fluid portion 117 of the cylinder assembly 100 would again drop and the gas pressure in the gas portion 118 would again cause the piston 103 to move in direction A2. Note, however, that the speed of motion in direction A2, as well as the flow rate of leaking hydraulic fluid, is now limited by the flow control valve 120. Thus, no matter how large the opening in the hydraulic line 122 may be, the flow rate of leaking hydraulic fluid will be limited and likewise the “spray” a person who may be near the liftgate would experience would also be limited. The particular flow control valve 120 used can be of any type chosen with sound engineering judgment. In one embodiment, the flow control valve 120 is placed very near or on the cylinder assembly 100, as shown.

Still referring to FIGS. 9-10, other advantages of the flow control valve 120 include control of the closing and opening rates and dampening of noise during operation.

Multiple embodiments have been described, hereinabove. It will be apparent to those skilled in the art that the above methods and apparatuses may incorporate changes and modifications without departing from the general scope of this invention. It is intended to include all such modifications and alterations in so far as they come within the scope of the appended claims or the equivalents thereof.

I/We claim:

1. A liftgate system comprising:
a deck having a cargo receiving surface; and,
an adjustment system for use in moving the deck, the adjustment system comprising:
a lift cylinder assembly for use in raising and lowering the deck; and,
a closer cylinder assembly for use in opening and closing the deck, the closer cylinder assembly comprising:
a barrel assembly;
a piston positioned within the barrel assembly;
a rod assembly connected to the piston;
a hydraulic fluid portion defined on one side of the piston;
a gas portion defined on the opposite side of the piston;
a hydraulic system that provides a hydraulic fluid to the hydraulic fluid portion of the closer cylinder to move the piston in order to close the deck; and,
a gas system that provides a gas to the gas portion of the closer cylinder to move the piston in order to open the deck.

2. The liftgate system of claim 1 wherein the liftgate system comprises a rail type liftgate.

3. The liftgate system of claim 1 wherein the gas system provides a compressible gas to the gas portion of the closer cylinder.

4. The liftgate system of claim 1 wherein the gas system further comprises:
an auxiliary device that stores a portion of the gas and that is operatively connected to the gas portion of the closer cylinder.

5. The liftgate system of claim 4 wherein the auxiliary device is a pneumatic accumulator.

6. The liftgate system of claim 4 wherein the auxiliary device is a pneumatic over hydraulic accumulator.

7. The liftgate system of claim 1 wherein the gas system further comprises:
a pressure relief valve operatively connected to the gas portion of the closer cylinder for use in preventing over-pressurization of the gas.

8. The liftgate system of claim 1 wherein the gas system further comprises:
a regulator for use in pre-setting the pressure of the gas within the gas system.

9. The liftgate system of claim 8 wherein the regulator is adjustable to provide the gas pressure at any pressure between 0 and 120 pounds per square inch (PSIG).

10. The liftgate system of claim 1 wherein the hydraulic system further comprises:
a flow control valve operatively connected to the hydraulic fluid portion of the closer cylinder for use in controlling the flow rate of the hydraulic fluid.

11. The liftgate system of claim 10 wherein the flow control valve 120 is placed very near or on the closer cylinder.

12. A liftgate system comprising:
a pair of uprights that may be attached to an associated vehicle;
a pair of runners that are vertically movable within the pair of uprights;
a deck having a cargo receiving surface that is attached to the pair of runners; and,
an adjustment system for use in moving the deck, the adjustment system comprising:
a lift cylinder assembly for use in raising and lowering the deck along the pair of uprights; and,
a closer cylinder assembly for use in opening and closing the deck, the closer cylinder assembly comprising:
a barrel assembly;
a piston positioned within the barrel assembly;
a rod assembly connected to the piston;
a hydraulic fluid portion defined on one side of the piston;
a gas portion defined on the opposite side of the piston;
a hydraulic system that provides a hydraulic fluid to the hydraulic fluid portion of the closer cylinder to move the piston in order to close the deck; and,
a gas system that provides a gas to the gas portion of the closer cylinder to move the piston in order to open the deck, the gas system comprising a regulator for use in pre-setting the pressure of the gas within the gas system.

13. The liftgate system of claim 12 wherein the gas system provides a compressible gas to the gas portion of the closer cylinder.

14. The liftgate system of claim 12 wherein the gas system further comprises:
an auxiliary device that stores a portion of the gas and that is operatively connected to the gas portion of the closer cylinder.

15. The liftgate system of claim 12 wherein the hydraulic system further comprises:
a flow control valve operatively connected to the hydraulic fluid portion of the closer cylinder for use in controlling the flow rate of the hydraulic fluid.

16. A method comprising the steps of:
providing a liftgate system comprising: a deck having a cargo receiving surface; and, an adjustment system for use in moving the deck;
providing the adjustment system comprising: a lift cylinder assembly for use in raising and lowering the deck; and, a closer cylinder assembly for use in opening and closing the deck;
providing the closer cylinder assembly comprising: a barrel assembly; a piston positioned within the barrel assembly; a rod assembly connected to the piston; a hydraulic fluid portion defined on one side of the piston; and, a gas portion defined on the opposite side of the piston;
supplying a hydraulic fluid to the hydraulic fluid portion of the closer cylinder to move the piston in order to close the deck; and,
supplying a gas to the gas portion of the closer cylinder to move the piston in order to open the deck.

17. The method of claim 16 wherein prior to the step of, supplying a gas to the gas portion of the closer cylinder to move the piston in order to open the deck, the method comprises the step of:
adjusting the gas pressure in the gas portion of the closer cylinder.

18. The method of claim 17 wherein the step of, adjusting the gas pressure in the gas portion of the closer cylinder, comprises the step of:
adjusting the gas pressure in the gas portion of the closer cylinder between 0 and 120 PSIG.

19. The method of claim 16 wherein the step of, supplying a gas to the gas portion of the closer cylinder to move the piston in order to open the deck, comprises the step of:
supplying a compressible gas to the gas portion of the closer cylinder.

20. The method of claim 16 wherein the step of, supplying a hydraulic fluid to the hydraulic fluid portion of the closer cylinder to move the piston in order to close the deck, comprises the step of:
controlling the flow rate of the hydraulic fluid.
